(19) United States
(12) Patent Application Publication
(10) Pub. No.: US 2026/0229197 A1
(43) Pub. Date: Aug. 6, 2026

(54) LIQUID CRYSTAL DISPLAY DEVICE AND METHOD OF CONTROLLING LIQUID CRYSTAL DISPLAY DEVICE

(71) Applicant: Sharp Display Technology Corporation, Kameyama City (JP)

(72) Inventor: Takashi SASAKI, Kameyama City (JP)

(21) Appl. No.: 19/462,054

(22) Filed: Jan. 28, 2026

(30) Foreign Application Priority Data
Feb. 3, 2025 (JP) 2025-015974

(51) Int. Cl. G09G 3/36

(52) U.S. Cl. CPC G09G 3/3648; G09G 3/3614; G09G 2300/0452; G09G 2330/021

(57) ABSTRACT

A liquid crystal display device includes a liquid crystal panel including a plurality of pixels disposed in two dimensions in a row direction and in a column direction, and a timing controller configured to control the liquid crystal panel. The plurality of pixels include pixels of a plurality of different colors disposed in the same order in the row direction, and in the liquid crystal panel, among the plurality of pixels, pixels of the same colors are disposed in the column direction, and the timing controller drives columns of pixels of one or more colors with relatively high visual sensitivities among the plurality of different colors by using a dot inversion driving method and drives columns of pixels of colors other than the one or more colors with the relatively high visual sensitivities by using a column inversion driving method.

### BACKGROUND

### 1. Field

The present disclosure relates to a liquid crystal display device and a method of controlling a liquid crystal display device.

### 2. Description of the Related Art

Liquid crystal layers used in liquid crystal display devices are susceptible to degradation if a voltage of the same polarity is continuously applied. Accordingly, liquid crystal display devices are typically designed to operate with alternating current drive.

Alternating current driving methods include frame inversion driving, line inversion driving, column inversion driving, dot inversion driving, and the like. An appropriate driving method is selected based on characteristics of the liquid crystal layer used in a liquid crystal display device, applications of the liquid crystal display device, and other factors.

However, depending on the alternating current driving method employed, when a specific image pattern is displayed on the liquid crystal display device, display quality degradation such as flickering or uneven display may occur. In addition, depending on the alternating current driving method, the power consumption of the liquid crystal display device may increase.

For example, Japanese Patent No. 3957403 and Japanese Patent No. 5456494 disclose liquid crystal display devices that are capable of suppressing such degradation in display quality.

The present disclosure relates to a liquid crystal display device capable of achieving high display quality with low power consumption, and a method of controlling a liquid crystal display device.

### SUMMARY

A liquid crystal display device according to an embodiment of the present disclosure includes a liquid crystal panel including a plurality of pixels disposed in two dimensions in a row direction and in a column direction, and a timing controller configured to control the liquid crystal panel. The plurality of pixels include pixels of a plurality of different colors disposed in the same order in the row direction, and in the liquid crystal panel, among the plurality of pixels, pixels of the same colors are disposed in the column direction, and the timing controller drives columns of pixels of one or more colors with relatively high visual sensitivities among the plurality of different colors by using a dot inversion driving method and drives columns of pixels of colors other than the one or more colors with the relatively high visual sensitivities by using a column inversion driving method.

### BRIEF DESCRIPTION OF THE DRAWINGS

FIG. 1 is a cross-sectional view schematically illustrating an example structure of a liquid crystal display device according to an embodiment;

FIG. 2 is a schematic view illustrating a structure of a TFT substrate in the liquid crystal display device illustrated in FIG. 1;

FIG. 3 is a circuit diagram illustrating pixels on the TFT substrate according to the first embodiment;

FIG. 4 is a schematic view illustrating an arrangement of red, green, and blue pixels in the liquid crystal display device;

FIG. 5 is a block diagram illustrating an example structure of a control device;

FIG. 6 is a diagram of the liquid crystal display device according to the first embodiment, illustrating example polarities of data signals applied to respective pixels;

FIG. 7 is a diagram of the liquid crystal display device according to the first embodiment, illustrating example polarities of data signals applied to respective pixels;

FIG. 8 is a diagram of a liquid crystal display device according to a second embodiment, illustrating example polarities of data signals applied to respective pixels;

FIG. 9 is a diagram of the liquid crystal display device according to the second embodiment, illustrating example polarities of data signals applied to respective pixels;

FIG. 10 is a circuit diagram illustrating pixels PX on a TFT substrate according to a third embodiment; and

FIG. 11 is a diagram of a liquid crystal display device according to the third embodiment, illustrating example polarities of data signals applied to respective pixels.

### DESCRIPTION OF THE EMBODIMENTS

Hereinafter, embodiments of the present disclosure will be described with reference to the attached drawings. The present disclosure is not limited to the embodiments described below, and design modifications may be made as appropriate within the scope fulfilling structures in the present disclosure. In addition, in the description below, the same reference numerals may be used commonly in different drawings for components that are the same or components that have similar functions, and their repeated descriptions may be omitted. In addition, structures described in the embodiments may be combined or modified as appropriate without departing from the scope of the present disclosure. For ease of understanding, in the drawings referred to below, such structural details may be simplified or illustrated schematically, and some components may be omitted. In addition, dimensional ratios among the components illustrated in the drawings do not necessarily represent actual dimensional ratios.

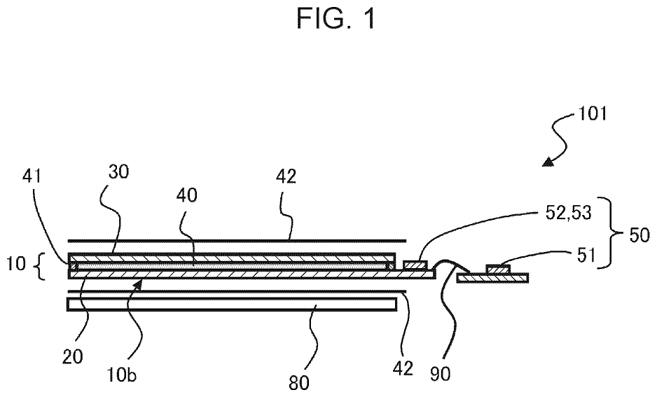

FIG. 1 is a cross-sectional view schematically illustrating an example structure of a liquid crystal display device 101 according to the embodiment. The liquid crystal display device 101 includes a liquid crystal panel 10 and a control device 50. The liquid crystal panel 10 includes a TFT substrate 20, an opposed substrate 30, and a liquid crystal layer 40. As will be described below, the liquid crystal panel 10 includes a plurality of pixels that are arranged in row and column directions. The liquid crystal layer 40 is disposed between the TFT substrate 20 and the opposed substrate 30, and is sealed between the TFT substrate 20 and the opposed substrate 30 with a seal 41.

The liquid crystal display device 101 may further include a pair of polarizing plates 42 and a backlight 80. The pair of polarizing plates 42 are disposed with the liquid crystal panel 10 therebetween in a state of crossed nicols.

The backlight 80 is disposed to face a rear surface 10b of the liquid crystal panel 10 with one of the pair of polarizing plates 42 therebetween. The backlight 80 may be an edge-lit backlight or a direct-lit backlight. In addition, the backlight 80 may be partially driven.

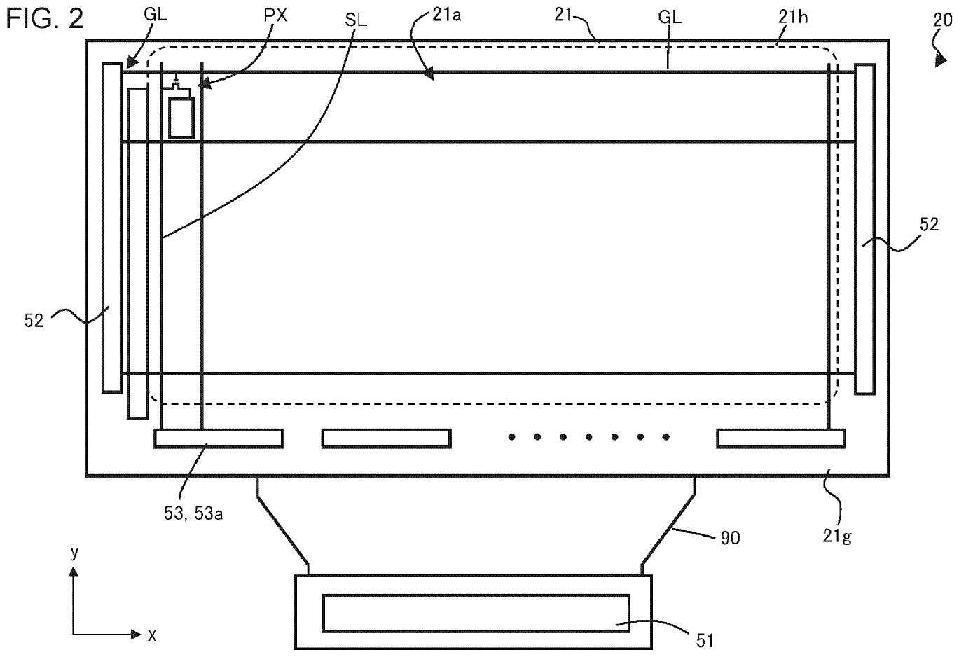

FIG. 2 is a schematic view illustrating an example structure of the TFT substrate 20. The TFT substrate 20 includes a substrate 21, a plurality of source lines (data signal lines) SL, a plurality of gate lines (scanning signal lines) GL, and a plurality of pixels PX.

The substrate 21 has a main surface 21a that has a display area 21h and a non-display area 21g, which is an area other than the display area 21h. The plurality of gate lines GL, the plurality of source lines SL, and the plurality of pixels PX are disposed in the display area 21h. Specifically, the plurality of gate lines GL extends in a row direction (x-direction) and are disposed at predetermined intervals in a column direction (y-direction), which intersects the row direction. The plurality of source lines SL extends in the column direction and are disposed at predetermined intervals in the row direction. Each pixel PX is disposed in an area surrounded by a pair of adjacent gate lines GL and a pair of adjacent source lines SL. The plurality of pixels PX is disposed in two dimensions in the row direction and in the column direction. The source lines SL and the gate lines GL extend to the non-display area 21g.

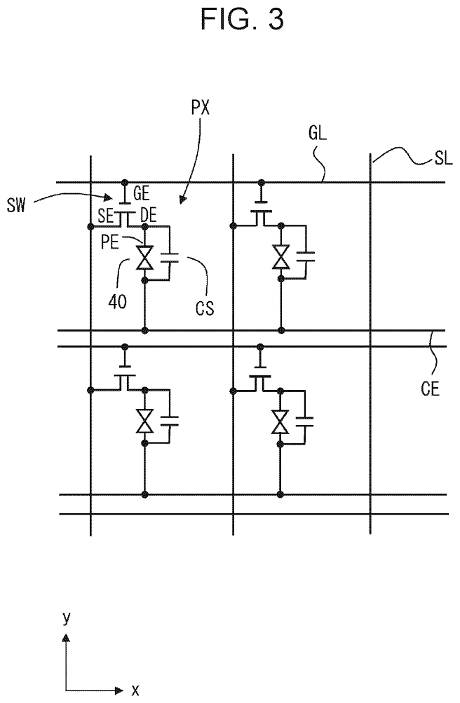

FIG. 3 is a circuit diagram illustrating the pixels PX on the TFT substrate 20 according to the embodiment. Each pixel PX includes a pixel electrode PE, a switching element SW, and a common electrode CE. The switching element SW is, for example, a thin-film transistor (TFT), which is a three-terminal element. The gate line GL, the source line SL, and the pixel electrode PE are connected to the three terminals respectively. For example, the switching element is a TFT that includes a gate electrode GE, a source electrode SE, and a drain electrode DE. The gate electrode GE is connected to the gate line GL, the source electrode SE is connected to the source line SL, and the drain electrode DE is connected to the pixel electrode PE and an auxiliary capacitor CS. With this structure, each pixel PX is connected to one of the plurality of gate lines GL and one of the plurality of source lines SL via the switching element SW.

Each gate line GL is connected to gate electrodes GE of TFTs in pixels PX that are disposed in the row direction among the plurality of pixels PX, whereas, each source line SL is connected to source electrodes SE of TFTs in pixels PX that are disposed in the column direction among the plurality of pixels PX.

The pixel electrodes PE are disposed to face the liquid crystal layer 40. The common electrode CE is, for example, a single plate or sheet-like conductive member that is connected between adjacent pixels PX and extends across the entire display area 21h, and is disposed between the pixel electrodes and the substrate 21. An insulating layer is disposed between the common electrode CE and the pixel electrodes PE. The common electrode CE is disposed across the entire display area 21h. An electric field is generated in the liquid crystal layer 40 when a voltage is applied between the pixel electrodes PE and the common electrode CE, and thereby the liquid crystal panel 10 is driven in a lateral electric field mode such as in Plane Switching (IPS) or Fringe Field Switching (FFS). With this structure, the liquid crystal panel 10 with a wide viewing angle can be provided.

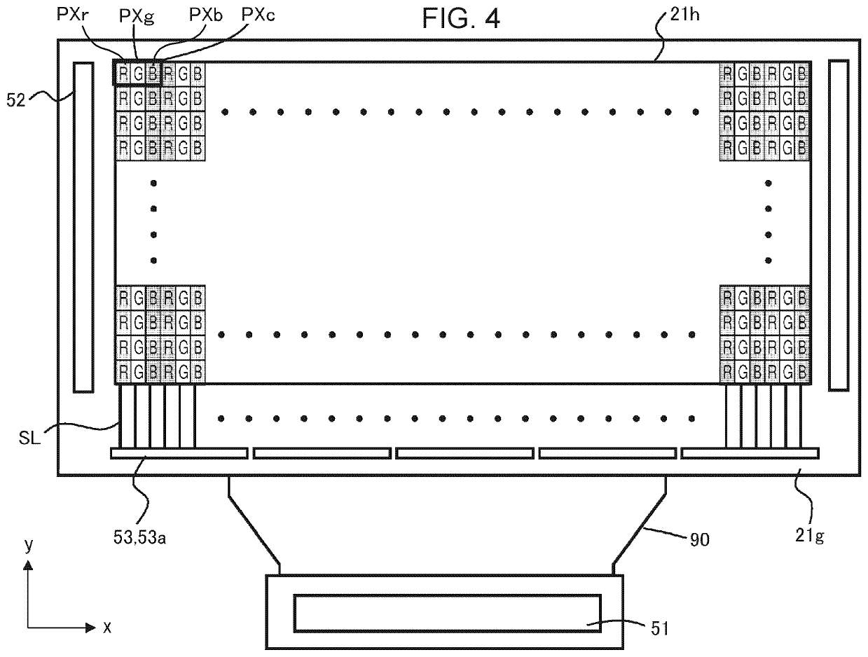

The plurality of pixels PX includes pixels of a plurality of different colors that are disposed repeatedly in the same order in the row direction. The pixels of the plurality of different colors include pixels of a color with a relatively high visual sensitivity. As illustrated in FIG. 4, in this embodiment, the plurality of different colors includes red (R), green (G), and blue (B), and the plurality of pixels PX include a plurality of red pixels PXr, a plurality of green pixels PXg, and a plurality of blue pixels PXb. Among red, green, and blue, green is a color with a relatively high visual sensitivity, and red and blue are colors with relatively low visual sensitivities. The arrangement and colors of the pixels are defined by a color filter that is disposed on the opposed substrate 30 or the TFT substrate 20.

The plurality of different colors is not limited to the three primary colors of red, green, and blue but may be four primary colors of red, green, blue, and yellow, or other combinations such as red, green, blue, and white, or the like. When the plurality of different colors includes red, green, blue, and yellow, a color with a relatively high visual sensitivity is yellow or green. When the plurality of different colors includes red, green, blue, and white, a color with a relatively high visual sensitivity is white or green. The visual sensitivities of the plurality of different colors may differ depending on optical characteristics of the color filter used.

The color with a relatively high visual sensitivity may be two or more colors. For example, when the plurality of different colors includes red, green, blue, and yellow, colors with relatively high visual sensitivities may be yellow and green, or when the plurality of different colors are red, green, blue, and white, colors with relatively high visual sensitivities may be white and green. In other words, the color with a relatively high visual sensitivity may comprise one or more colors. The number of colors selected as colors with relatively high visual sensitivities can be determined in consideration of the balance between the effect of suppressing the occurrence of vertical stripes and the effect of suppressing an increase in power consumption.

A color pixel PXc includes three pixels adjacent in the row direction: a red pixel R, a green pixel G, and a blue pixel B. This color pixel PXc is capable of displaying an achromatic color or any desired color. A red pixel PXr, a green pixel PXg, and a blue pixel PXb are referred to as subpixels, and a group of these three subpixels may also be referred to as a pixel.

In the column direction, pixels of the same color are disposed, and red pixel columns Colr, green pixel columns Colg, and blue pixel columns Colb are formed. The green pixel columns Colg are columns of pixels of a color with a relatively high visual sensitivity among the plurality of different colors. Each pixel in the column of pixels is connected to one of the source lines.

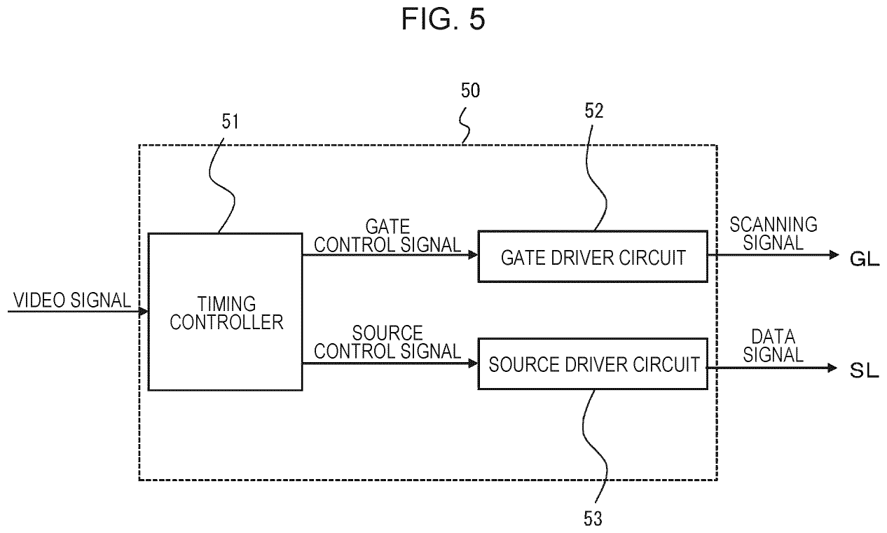

FIG. 5 is a block diagram illustrating an example structure of the control device 50. The control device 50 includes a timing controller 51, a gate driver circuit 52, and a source driver circuit 53. The control device 50 includes electronic circuits that include active components such as ICs, LSIs, FETs, or the like, and passive components such as resistors, capacitors, or the like.

The timing controller 51 receives external video signals. Such video signals include video data signals and video synchronization signals. The timing controller 51 generates gate control signals and source control signals based on received video signals.

The gate control signals include, for example, gate start pulse signals, gate clock signals, gate clear signals, and the like. The source control signals include, for example, image signals, polarity control signals, and the like.

The gate driver circuit 52 and the source driver circuit 53 are disposed in the non-display area 21g in the substrate 21, as illustrated in FIG. 2. The gate driver circuit 52 is connected to at least one end of a gate line GL. The source driver circuit 53 is connected to one end of a source line SL. The timing controller 51 is connected, for example, via a flexible printed circuit (FPC) 90.

The gate driver circuit 52 and the source driver circuit 53 may be packaged components that are covered with resin or similar material, or bare chips, and may be mounted in the non-display area 21g of the substrate 21. Alternatively, the gate driver circuit 52 and the source driver circuit 53 may be a monolithic driver that includes a plurality of TFTs or similar components that are fabricated in the non-display area 21g of the substrate 21.

In this embodiment, the gate driver circuit 52 is disposed at each end of the gate lines GL. The gate driver circuit 52 is, like the TFTs, which are switching elements SW of the pixels PX, a monolithic driver that is integrally formed with the substrate 21 together with TFTs or similar components formed on the substrate 21. In this embodiment, the source driver circuit 53 includes a plurality of source driver chips 53a. The source driver chips 53a are bare chips and are mounted on the substrate 21.

The gate driver circuit 52 receives a gate control signal, generates a plurality of scanning signals, and outputs the plurality of scanning signals to a plurality of gate lines GL respectively. The source driver circuit 53 receives a source control signal, generates a plurality of data signals, and outputs the plurality of data signals to a plurality of source lines SL respectively. The plurality of data signals contains voltage values that correspond to gradation display of respective pixels. Each of the voltage values has a polarity determined by a polarity control signal and takes a positive (+) or negative (−) value with respect to a reference potential (potential applied to the common electrode).

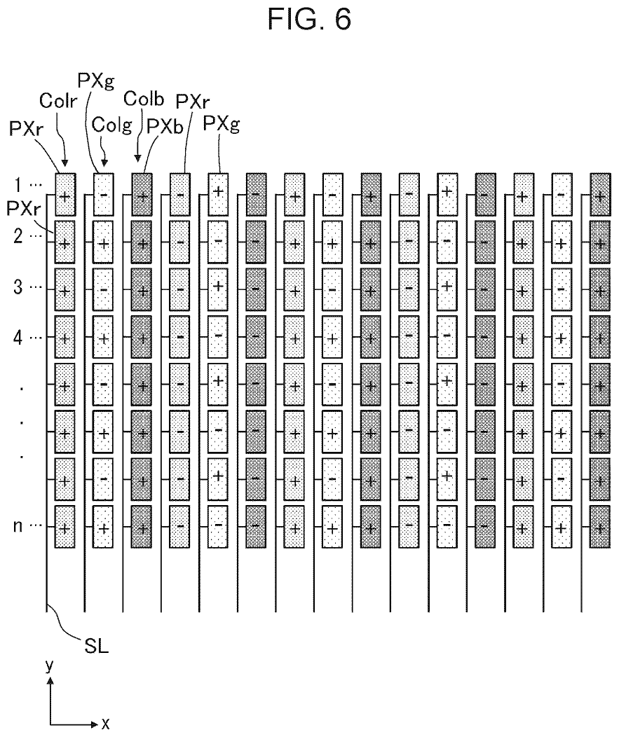

Next, a method of controlling the liquid crystal display device 101 will be described. FIG. 6 is a diagram illustrating example polarities of data signals applied to respective pixels when the liquid crystal panel 10 is driven by using an alternating current driving method in this embodiment. The signs “+” and “−” indicate, as described above, that the voltage applied to the pixel is positive or negative with respect to the reference potential. By applying data signals, each of the pixel electrodes PE in respective pixels is also maintained at a positive or negative potential with respect to the reference potential.

The timing controller 51 drives columns of pixels of a color with a relatively high visual sensitivity among the plurality of different colors of the color pixels by using a dot inversion driving method, and drives columns of pixels of colors other than the color with the relatively high visual sensitivity by using a column inversion driving method. The dot inversion driving method here refers to inversion driving performed every one row, every two rows, or the like, i.e., inversion on a per-row or multi-row basis. When there are two colors with relatively high visual sensitivities, the columns of pixels of those two colors are driven by using the dot inversion driving method, and the columns of pixels of the other colors are driven by using the column inversion driving method. In this embodiment, the timing controller 51 drives green pixel columns Colg by using the dot inversion driving (1H dot inversion driving) method every one row, and drives the red pixel columns Colr and the blue pixel columns Colb by using the column inversion driving method. Each pixel in the green pixel columns Colg is connected to one source line SL, and the polarity of the data signals inverts when the gate driver circuit 52 outputs scanning signals to respective gate lines GL. Accordingly, the polarity of the green pixels PXg is alternately inverted in the column direction.

In contrast, data signals of the same polarity are applied uniformly to the pixels in the column direction for the red pixel columns Colr and the blue pixel columns Colb. Data signals of the opposite polarity are applied to the red pixel columns Colr and the blue pixel columns Colb, which are adjacent in the row direction, respectively. By applying the data signals, the pixel electrodes PE in the respective pixels PX become to have potentials of the same polarity as the data signals with respect to the reference potential, and the potentials are maintained for one frame period.

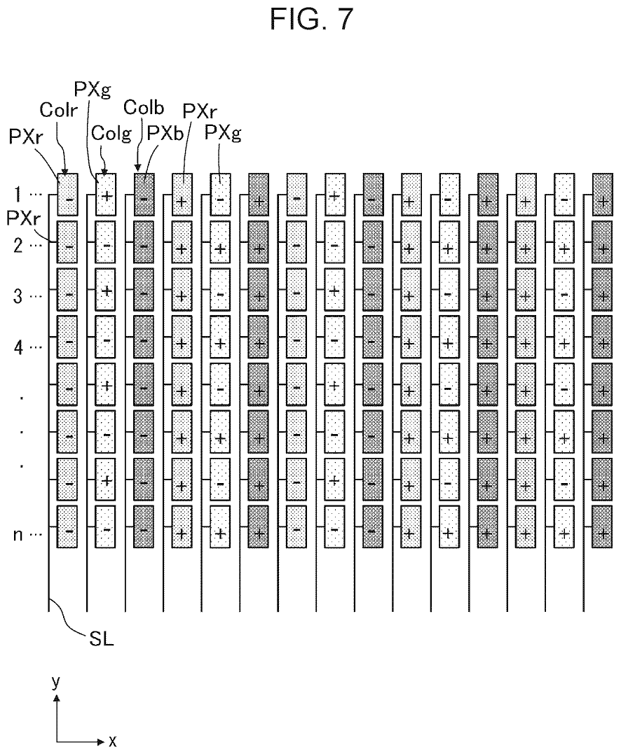

FIG. 7 illustrates the polarity of data signals applied to the respective pixels in a frame subsequent to the frame in which the data signals were supplied with the polarity illustrated in FIG. 6 and the liquid crystal panel 10 was driven. As illustrated in FIG. 7, the polarity of the data signals applied to the respective pixels is inverted in the subsequent frame.

Driving the liquid crystal panel by using the column inversion driving method is beneficial because it enables low power consumption. However, when the entire screen is displayed in an intermediate color (gray), even a slight deviation of the common electrode potential from its optimal value causes a brightness difference between pixels receiving positive data signals and pixels receiving negative data signals. For example, when the common electrode potential deviates slightly toward the positive side from the optimal value, the potential differences between the pixel electrodes and the reference electrode become smaller than a set value in the pixels receiving the positive data signals, whereas the potential differences between the pixel electrodes and the reference electrode become larger than the set value in the pixels receiving the negative data signals. This causes, for example, the brightness of the red pixel columns and the blue pixel columns to decrease and the brightness of the green pixel columns to increase. As a result, vertical stripes appear in the column direction in the display of an intermediate color, which is supposed to be uniform.

In the liquid crystal display device according to the embodiment, some pixels are driven by the dot inversion driving method, whereas the rest of the pixels are driven by the column inversion driving method. Accordingly, the occurrence of such vertical stripes can be suppressed in the pixels that are driven by the dot inversion driving method. In particular, since the green pixels with a high visual sensitivity are driven by using the dot inversion driving method, such vertical stripes are less noticeable in terms of visual characteristics.

However, the driving by using the dot inversion driving method consumes more power than the column inversion driving method. In the liquid crystal display device according to the embodiment, an increase in power consumption can be suppressed by limiting the pixels driven by the dot inversion driving method.

Accordingly, high display quality can be achieved in the liquid crystal display device and the method of controlling the liquid crystal display device according to the embodiment.

### Second Embodiment

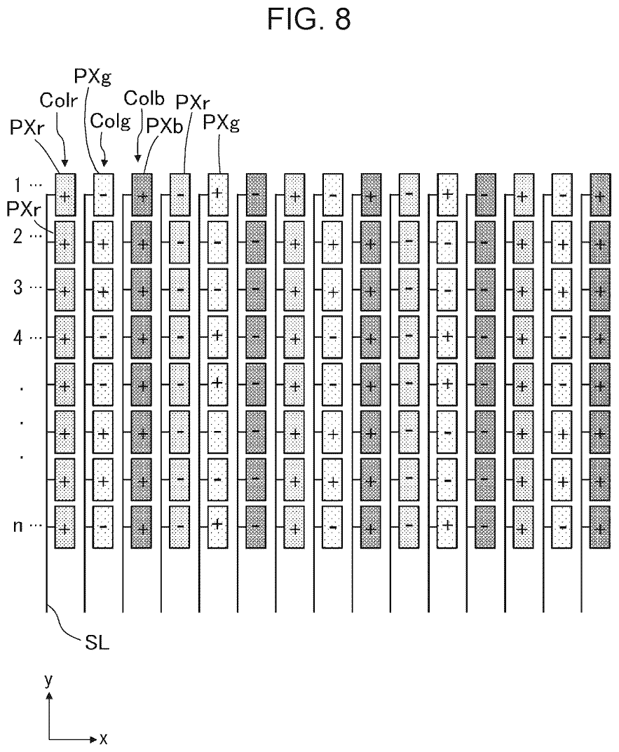

FIG. 8 is a diagram illustrating the polarity of data signals applied to respective pixels when the liquid crystal panel 10 is driven by an alternating current driving method, in this embodiment. In the first embodiment, the polarity of green pixels alternates on the per-pixel basis in the column direction. In this embodiment, the green pixel columns are driven by a dot inversion driving (2H dot inversion driving) method every two rows. The red pixel columns and the blue pixel columns are driven by the column inversion driving method as in the first embodiment.

According to such a driving method, the polarity of the source lines connected to the green pixel columns is inverted every time two gate lines are scanned. The period of inversion becomes longer than in the first embodiment, and thus the power consumption can be reduced compared to the first embodiment even when the dot inversion driving method is employed.

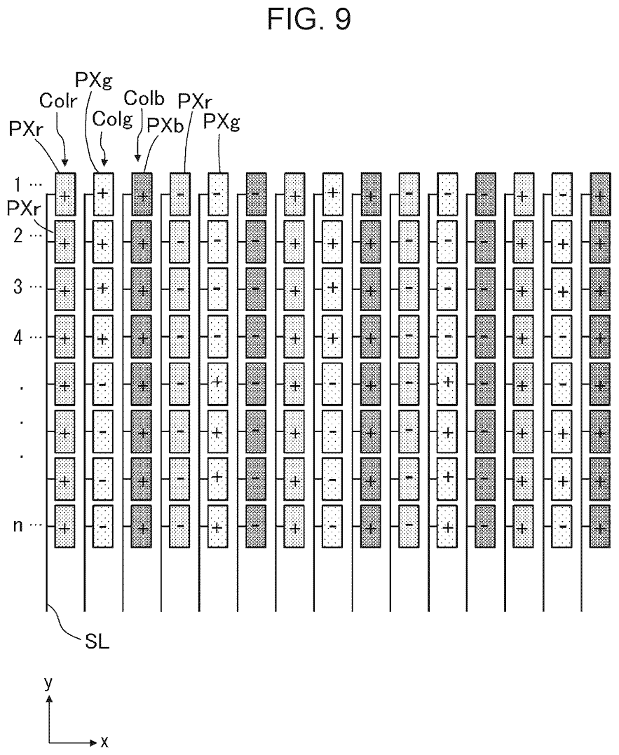

FIG. 9 is a diagram illustrating the polarity of data signals applied to respective pixels when the green pixel columns are driven by a dot inversion driving (4H dot inversion driving) method every four rows. The green pixel columns are driven by the dot inversion driving method every four rows, and the red pixel columns and the blue pixel columns are driven by the column inversion driving method as in the first embodiment. Compared with the dot inversion performed every two rows, the period in which the polarity of the source lines inverts can be extended, and thus the power consumption can be further reduced.

In the green pixel columns, however, when pixels of the same polarity continue for an extended length, vertical stripes become more likely to be visible. The appearance of vertical stripes varies depending on the size and resolution of the liquid crystal panel 10 and the usage conditions of the liquid crystal display device. Accordingly, the number of rows for dot inversion in the green pixel columns can be determined depending on these factors.

### Third Embodiment

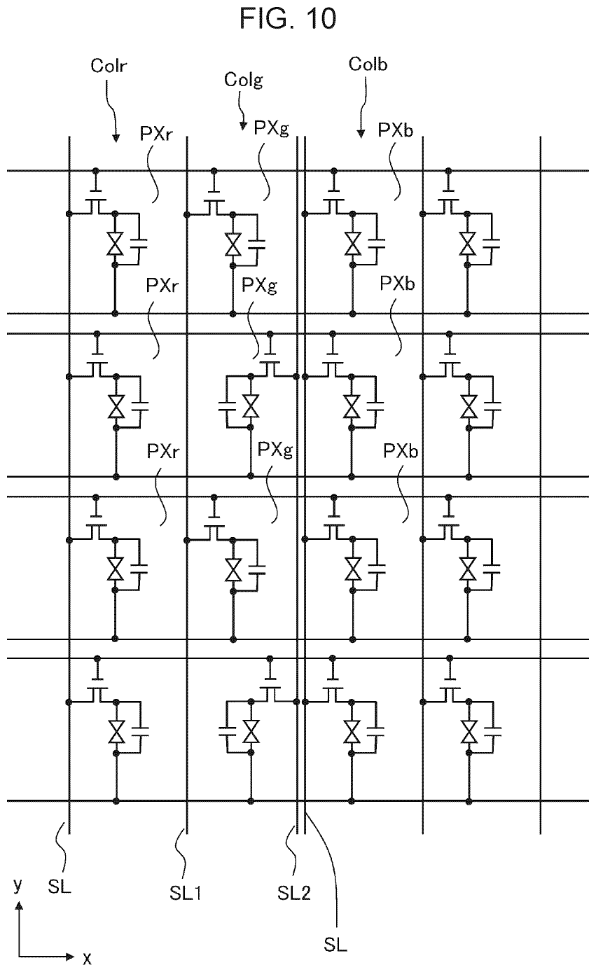

FIG. 10 is a circuit diagram illustrating the pixels PX on the TFT substrate 20 of the liquid crystal display device according to the embodiment. As in the first embodiment, each of the red pixel columns and blue pixel columns is connected to one source line SL. In contrast, each green pixel column is connected to two source lines SL. More specifically, a plurality of green pixels disposed in the column direction are alternately connected to two source lines SL.

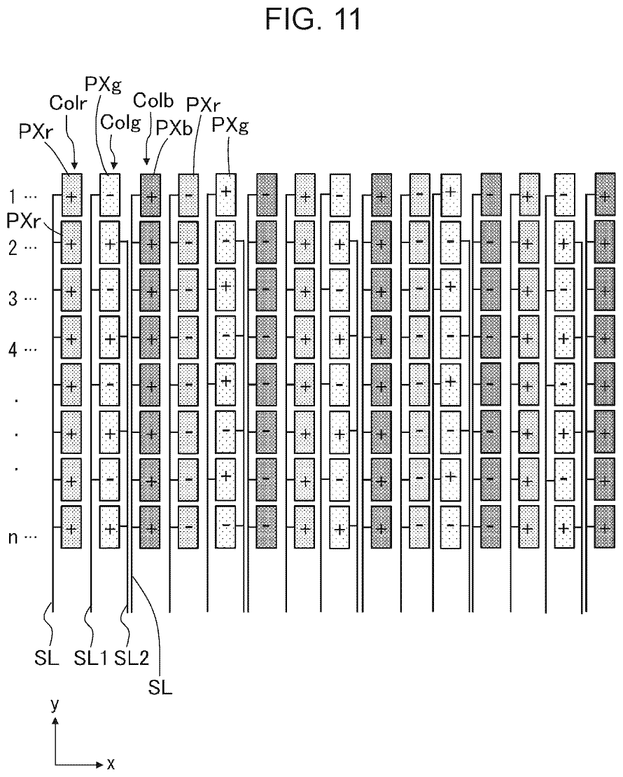

As illustrated in FIG. 10, when two source lines are referred to as a source line SL1 and a source line SL2, in the green pixel column, odd-numbered pixels are connected to the source line SL1, and even-numbered pixels are connected to the source line SL2. FIG. 11 is a diagram illustrating the polarity of data signals applied to respective pixels when the liquid crystal panel 10 is driven by using an alternating current driving method, in this embodiment.

As in the first embodiment, the red pixel columns and the blue pixel columns are each driven by using the column inversion driving method. The green pixel columns are driven by using the dot inversion driving method, and the polarity of the plurality of green pixels disposed in the column direction is alternately inverted.

The green pixel columns are driven by the source lines SL1 and the source lines SL2. The source lines SL1 and the source lines SL2 output data signals to the green pixels with opposite polarities during one frame period. During one frame period, the polarities of the source lines SL1 and source lines SL2 are constant and do not change (invert). In other words, as in the column inversion driving method, the polarities of the source lines SL1 and source lines SL2 do not change during one frame period.

In the example illustrated in FIG. 11, the source line SL1 supplies a data signal of negative polarity to the green pixel column, and the source line SL2 supplies a data signal of positive polarity to the green pixel column. When the gate lines GL are scanned in the column direction, the TFTs of the green pixels are turned on, and thereby the data signal of negative polarity supplied from the source line SL1 and the data signal of positive polarity supplied from the source line SL2 are sequentially supplied to the green pixels. As a result, the polarity of the data signals is alternately inversed as the green pixel column, and the green pixel column is driven by the dot inversion driving method every one row.

The liquid crystal display device according to the embodiment, as in the first embodiment, suppresses the occurrence of vertical stripes when the entire screen is displayed in an intermediate color. In addition, since each green pixel column is driven by two source lines, it is not necessary to invert the polarity of the data signal at the timing of gate line scanning during one frame period. Accordingly, the power consumption can be further reduced compared with the liquid crystal display device according to the first embodiment.

The liquid crystal display devices and the method of controlling the liquid crystal display devices according to the present disclosure can also be described as follows.

A liquid crystal display device according to a first structure includes a liquid crystal panel including a plurality of pixels disposed in two dimensions in a row direction and in a column direction, and a timing controller configured to control the liquid crystal panel, in which the plurality of pixels include pixels of a plurality of different colors disposed in the same order in the row direction, and in the liquid crystal panel, among the plurality of pixels, pixels of the same colors are disposed in the column direction, and the timing controller drives columns of pixels of one or more colors with relatively high visual sensitivities among the plurality of different colors by using a dot inversion driving method and drives columns of pixels of colors other than the one or more colors with the relatively high visual sensitivities by using a column inversion driving method.

According to the first structure, columns of pixels of one or more colors with relatively high visual sensitivities are driven by using a dot inversion driving method and thus visible vertical stripes can be suppressed even when an image is displayed with a single intermediate color. In addition, since only some pixels are driven by using a dot inversion driving method, the overall power consumption of the liquid crystal display device can be suppressed.

A liquid crystal display device according to a second structure, in the first structure, the pixels of the plurality of different colors may include a red pixel, a blue pixel, and a green pixel, the plurality of pixels may include a plurality of red pixels, a plurality of green pixels, and a plurality of the blue pixels, and the pixels of one or more colors with relatively high visual sensitivities may include the green pixels.

A liquid crystal display device according to a third structure, in the second structure, the timing controller may drive the columns of green pixels every one row by using the dot inversion driving method.

A liquid crystal display device according to a fourth structure, in the second structure, the timing controller may drive the columns of green pixels every two rows by using the dot inversion driving method.

A liquid crystal display device according to a fifth structure, in the second structure, the timing controller may drive the columns of green pixels every four rows by using the dot inversion driving method.

A liquid crystal display device according to a sixth structure, in the second structure, the liquid crystal panel may further include a plurality of source lines extending in the column direction and a source driver circuit connected to the plurality of source lines. Each column of the red pixels and each column of the blue pixels may be connected to one of the plurality of source lines respectively, and each column of the green pixels may be connected to one or two of the plurality of source lines.

A liquid crystal display device according to a seventh structure, in the second structure, each column of the green pixels may be connected to two of the plurality of source lines, and in each column of the green pixels, the plurality of green pixels disposed in the column direction may be alternately connected to one of the two source lines respectively.

A method of controlling a liquid crystal display device according to an eighth structure, the liquid crystal display device including a liquid crystal panel including a plurality of pixels disposed in two dimensions in a row direction and in a column direction, and a timing controller configured to control the liquid crystal panel, in which the plurality of pixels include pixels of a plurality of different colors disposed in the same order in the row direction, and in the liquid crystal panel, among the plurality of pixels, pixels of the same colors are disposed in the column direction, the method includes driving columns of pixels of one or more colors with relatively high visual sensitivities among the plurality of different colors by using a dot inversion driving method and driving columns of pixels of colors other than the one or more colors with the relatively high visual sensitivities by using a column inversion driving method.

The present disclosure contains subject matter related to that disclosed in Japanese Priority Patent Application JP 2025-015974 filed in the Japan Patent Office on Feb. 3, 2025, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a liquid crystal panel including a plurality of pixels disposed in two dimensions in a row direction and in a column direction; and
a timing controller configured to control the liquid crystal panel, wherein
the plurality of pixels includes pixels of a plurality of different colors disposed in the same order in the row direction, and in the liquid crystal panel, among the plurality of pixels, pixels of the same colors are disposed in the column direction, and
the timing controller drives columns of pixels of one or more colors with relatively high visual sensitivities among the plurality of different colors by using a dot inversion driving method and drives columns of pixels of colors other than the one or more colors with the relatively high visual sensitivities by using a column inversion driving method.

2. The liquid crystal display device according to Claim 1, wherein the pixels of the plurality of different colors include a red pixel, a blue pixel, and a green pixel,
the plurality of pixels includes a plurality of red pixels, a plurality of green pixels, and a plurality of the blue pixels, and
the pixels of one or more colors with relatively high visual sensitivities include the green pixels.

3. The liquid crystal display device according to Claim 2, wherein the timing controller drives the columns of green pixels every one row by using the dot inversion driving method.

4. The liquid crystal display device according to Claim 2, wherein the timing controller drives the columns of green pixels every two rows by using the dot inversion driving method.

5. The liquid crystal display device according to Claim 2, wherein the timing controller drives the columns of green pixels every four rows by using the dot inversion driving method.

6. The liquid crystal display device according to Claim 2, wherein the liquid crystal panel further comprises a plurality of source lines extending in the column direction and a source driver circuit connected to the plurality of source lines,
each column of the red pixels and each column of the blue pixels are connected to one of the plurality of source lines respectively, and
each column of the green pixels is connected to one or two of the plurality of source lines.

7. The liquid crystal display device according to Claim 2, wherein each column of the green pixels is connected to two of the plurality of source lines, and
in each column of the green pixels, the plurality of green pixels disposed in the column direction are alternately connected to one of the two source lines respectively.

8. A method of controlling a liquid crystal display device including
a liquid crystal panel including a plurality of pixels disposed in two dimensions in a row direction and in a column direction; and
a timing controller configured to control the liquid crystal panel, wherein
the plurality of pixels includes pixels of a plurality of different colors disposed in the same order in the row direction, and in the liquid crystal panel, among the plurality of pixels, pixels of the same colors are disposed in the column direction, the method comprising:
driving columns of pixels of one or more colors with relatively high visual sensitivities among the plurality of different colors by using a dot inversion driving method and driving columns of pixels of colors other than the one or more colors with the relatively high visual sensitivities by using a column inversion driving method.
